(19) United States
(12) Patent Application Publication
(10) Pub. No.: US 2008/0086540 A1
(43) Pub. Date: Apr. 10, 2008

(54) Method and system for executing a normally online application in an offline mode

(76) Inventors: James Scott, Riverview (CA); Stephen Savage, Fredericton (CA)

Correspondence Address: CASSAN MACLEAN, 307 GILMOUR STREET, OTTAWA, ON, K2P 0P7, US

(21) Appl. No.: 11/543,896

(22) Filed: Oct. 6, 2006

(51) Int. Cl. G06F 15/16

(52) U.S. Cl. 709/217

(57) ABSTRACT

Methods and systems for executing an online application in an offline environment. A bootstrap module is downloaded from the server to the client when an offline mode is selected for the normally online application. The bootstrap module extracts an appropriate offline module also downloaded from the server. The offline module determines which resources on the server may be accessed by the application, downloads these resources, and saves them on the client computer. When in the offline mode, any accesses that the application may make to the server are intercepted on the client computer and the resources required to satisfy the request are determined and found on the client computer from the downloaded resources. When the application goes online again, any changes made by the application to the resources on the client computer are uploaded to the server such that these changes are also reflected on the server resources.

### FIELD OF THE INVENTION

The present invention relates to software normally for use in an online environment and how that software may be made available in an offline mode with minimum changes. More specifically, the present invention relates to methods and systems for executing normally online applications in an offline environment.

### BACKGROUND OF THE INVENTION

The ubiquity of the Internet has given rise to the migration of common, everyday transactions and tasks to the online world. Even the task of filling out timesheets, for project management, time tracking, or payroll purposes, may now be done online. Such an approach can ensure that the data is entered in a timely manner and that up to date data is available to those who may have need of it.

Current timesheet software packages that allow online entry of data typically require a connection to the Internet. These timesheet software packages are online applications that require a user's computer to be connected, via a network connection to the Internet, to a specific server computer while data is being entered into the timesheet. Generally, it is said that an application (a software program or group of programs designed for end users) is an online application if it requires a network connection to perform its main functions or to accomplish its tasks.

The need for a connection to the Internet/Intranet limits the usability of these online timesheet applications as such a connection may not always be available. As an example, a user at a job site may wish to enter data in a timesheet online application. However, because the job site may not have a connection to the Internet available, the user would be unable to enter data. As such, the user may need to take note of the data to be entered and enter it once he/she finds a suitable Internet/Intranet connection. While this may not sound onerous, if the data set to be entered is large, noting such a data set and entering it at a later time is akin to entering it twice.

While it is possible to adapt online applications, such as the timesheet application, for use in an offline environment, this approach may not be advisable. The offline counterparts may not function in the same manner as the original online application. Furthermore, some of these offline versions of online applications use a different user interface. Such shortcomings may require further user training. Other offline versions are unable to provide the same functionality as their online counterparts.

As an example of a previous attempt to turn online web applications into offline applications, Kraenzel et al. (U.S. Pat. No. 6,854,016) discloses taking an online application offline, making changes to the application, and then synchronizing the changes with the online version of the application. However, this process involves having the web site developer and the web site administrator configure and set up the application prior to a user taking the application offline. This approach also involves a possibly lengthy download process for the user as all the databases required by the offline application from the online server are replicated on the user's machine.

Another approach towards turning a normally online application into an offline application is that disclosed by Sneh in US Patent Application Publication US 2005/0188051. This approach involves editing the source HTML (Hypertext Markup Language) code files of the online application to insert OTML (Offline Tagging Markup Language) tags. These OTML tags adjust the web interface for offline use by disabling buttons, fields, and other capabilities not accessible when the application is offline. Unfortunately, this approach requires possibly lengthy editing of the source code of the application. Furthermore, the approach involves the web developer tasked with editing the source code to learn and familiarize himself with a new tagging language, OTML. However, possibly the greatest issue with this approach is the lack of real-time feedback capabilities for an offline user.

A further approach to running normally online applications in an offline mode is that disclosed in US Patent Application Publication US 2005/0197819 by Hopkins et al. For this approach, all the resources required by the web application are replicated on the user's machine. Application server software and the database it accesses, both normally stored in and executed on a remote server, are stored and executed on the user's machine along with the user software used to access these resources. This approach does not readily lend itself to easily switching from an online mode to an offline mode or from an offline mode to an online mode. The resources have to be stored and enabled on the user's machine prior to converting to an offline mode. If the database is large, long download times may be required.

Yet another approach, similar to that used by Hopkins, et al. is that used by Fischer et al. in PCT Application WO 02/099596. Fischer et al. also replicate all the resources required by an offline web application on the user's machine. A single-threaded, small footprint Java-based web server is installed on the user's machine and this web server services the needs of the offline application. Similar to Hopkins, the complete database is stored on the user's machine. To conserve storage space, applications are deleted or installed as required. It should be noted that this approach is described by Fischer et al. generally in relation to a mobile device configured to run offline web applications. Large databases are not contemplated by Fischer et al. and may require, again, lengthy download times.

The above approaches have a number of common drawbacks. They either require extensive modifications to the application or they require lengthy download times, especially if the databases required by the application are large. Also, no mechanism is provided whereby an end user can easily switch between online and offline modes of the application. Similarly, no mechanism is provided such that an online application can determine which files may be needed by its offline counterpart. Finally, while some of the approaches above may arguably provide an offline experience with the application that is similar to the online experience, this is only achieved by completely replicating the server software and the server configuration on the user's machine. Replicating the server software and the server configuration on the user's machine would require an installation that is unavailable to users in a normal permissions-based environment. This requirement would complicate the deployment of offline web-based software.

Based on the above, there is therefore a need for offline applications that not only provide the same functionality as their online counterparts but which also provide the same user interface. Ideally, such a solution should not require a substantial rewrite or amendment of the online version of the application. It is also preferred if such a solution allowed online applications to automatically determine which of its online files may be needed by its offline counterpart and if such a solution provided for an automated download process so that these files may be replicated on the user's machine. It is also desirable that long download times, usually associated with replicating the server database on a user's machine, be avoided.

It should be noted that the term “offline” denotes a non-requirement for a network connection. As such, an offline application denotes an application that does not require a connection to resources stored on another computer to perform its main functions or to accomplish its tasks. An “offline mode” for an application is therefore a mode for the application in which the application does not require a network connection to another computer to execute its main functions.

In contrast, it should be noted that the term “online” denotes a requirement for a network connection to other machines. Thus, an online application is one which requires a network connection to other computers so that the application may access resources resident on those other computers. By extension, an application's “online mode” is therefore that application's mode which requires a network connection to at least one other computer and to its resources.

### SUMMARY OF THE INVENTION

The present invention provides methods and systems for executing an online application in an offline environment. In one aspect of the invention, a bootstrap module is downloaded from the server to the client when an offline mode is selected for the normally online application. The bootstrap module extracts an appropriate offline module also downloaded from the server. The offline module determines which resources on the server may be accessed by the application, downloads these resources, and saves them on the client computer. When in the offline mode, a connection is opened to a network port within the offline module and any accesses that the application may make to the server are handled appropriately by sending back the normally expected server responses. This may include HTTP-like requests such as GETs or POSTs. When the application goes online again, any changes made by the application to the resources on the client computer are uploaded to the server such that these changes are also reflected on the server resources.

In a first aspect the present invention provides a system for executing a normally online subject application in an offline mode on a client computer, the system comprising:

an offline server application executed on said client computer, said offline server application being for receiving and responding to requests from said subject application;

offline resources saved on said client computer, said offline resources being at least a subset of resources normally resident on a server remote from said client computer, said offline resources being for use by said subject application by way of said requests to said offline server application;

database resources stored on said client computer for use by said subject application by way of said requests to said offline server application, said database resources being representative of a subset of data stored on said server.

In a second aspect the present invention provides a method for executing a normally online subject application in an offline mode on a client computer, the method comprising:

a) downloading resources from a server and installing said resources on said client computer, said resources being for use by said subject application and said resources normally being accessed by said subject application from said server when said subject application is in an online mode;

b) directing server accesses and requests by said subject application to an offline server application installed on said client computer, said offline server application being for receiving and responding to said requests from said subject application using said resources downloaded in step a).

In a third aspect of the invention, there is provided an offline server application for use with a normally online subject application when said subject application is in an offline mode, the offline server application being executed on a client computer and comprising:

a resource download module for downloading resources normally resident on a server remote from said client computer, said resources being for use by said subject application by way of requests to said offline server application, said resources being saved on said client computer by said offline server application;

a request handling module for receiving and handling requests from said subject application using resources downloaded from said server;

an online conversion module for synchronizing resources between said client computer and said server.

### BRIEF DESCRIPTION OF THE DRAWINGS

A better understanding of the invention will be obtained by considering the detailed description below, with reference to the following drawings in which:

FIG. 1 is a diagram of a client/server system according to the prior art illustrating how an application on the client machine communicates with the server.

FIG. 2 is a diagram of the client/server system of FIG. 1 with the subject application being executed through an Internet web browser.

FIG. 3 is a diagram of one aspect of the invention illustrating that server requests/accesses by the subject application is intercepted and redirected.

FIG. 4 is a flowchart of a method for converting a normally online application to function in an offline environment.

FIG. 5 is a flowchart of a method executed on the client computer when a request/access from the subject application is intercepted during an offline mode.

FIG. 6 is a flowchart of a method executed when reconverting the subject application from an offline mode to its normally online mode.

FIG. 7 is a schematic illustration of modules which may be used by an offline server application.

### DETAILED DESCRIPTION

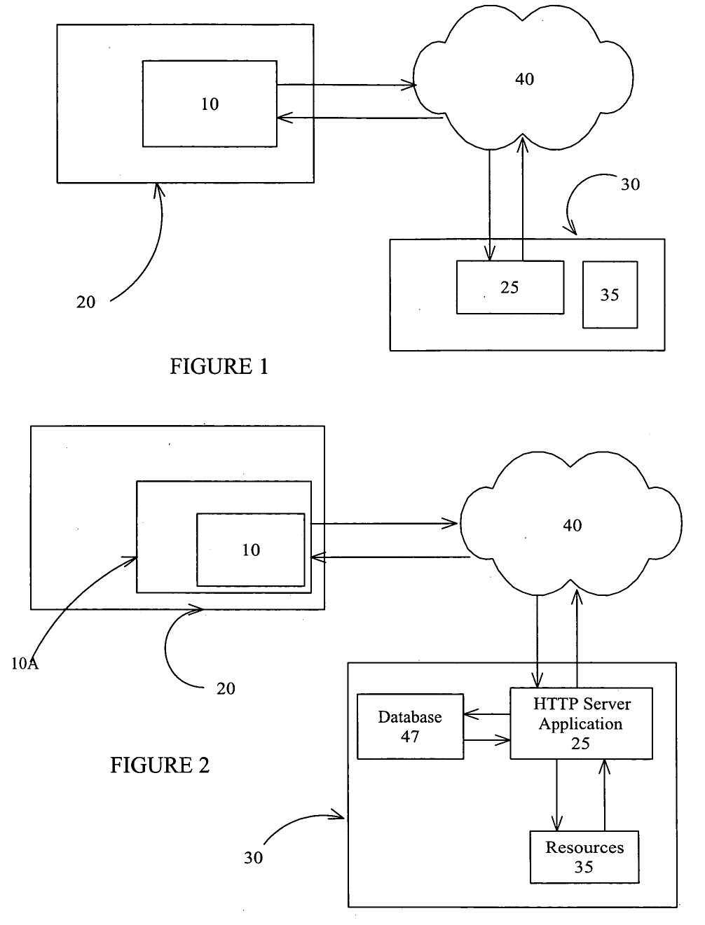

Referring to FIG. 1, a schematic diagram of a normally online application in use is illustrated. The online application 10 operates on a client computer 20 and communicates with a server application 25 in a computer 30 via a network 40. The subject application 10 contacts the server application 25 in the server computer 30 and, when necessary, requests either copies of or access to resources 35 located on the server computer 30. The server application 25 in server computer 30, for its part, provides such access and such copies as long as the subject application 10 is authenticated (if required).

Referring to FIG. 2, one type of an online application is illustrated. In this type of online application, the subject application 10 operates through a web browser 10A on the client computer 20. The browser 10A communicates with the server 30 through the network 40. The browser 10A, based on the needs of the application 10 (which may be an HTML/XHTML based application), requests resources from server application 25 (an HTTP server application in one embodiment) running on the server computer 30. The browser 10A requests images, data files, HTML files, XML files, etc., from the server application 25. If the request from browser 10A requires it, the server application 25 may access a database 47. The access of the server application 25 to the database 47 may take the form of retrieving data from or writing data to the database 47.

It should be noted that while FIG. 2 illustrates the database server 47 as being on the same computer as the server application 25 and the resources 35, it is possible that the database 47 may be located on a different computer from the server application 25 or from the resources 35.

In the configuration of the system in FIG. 2, the browser 10A requests data through the server application 25. The server application 25 then retrieves data from the database 47 and forwards the retrieved data to the browser 10A. To manipulate and write data, the browser 10A requests such actions from the server application 25. The server application 25 then executes the requested actions (if authorized).

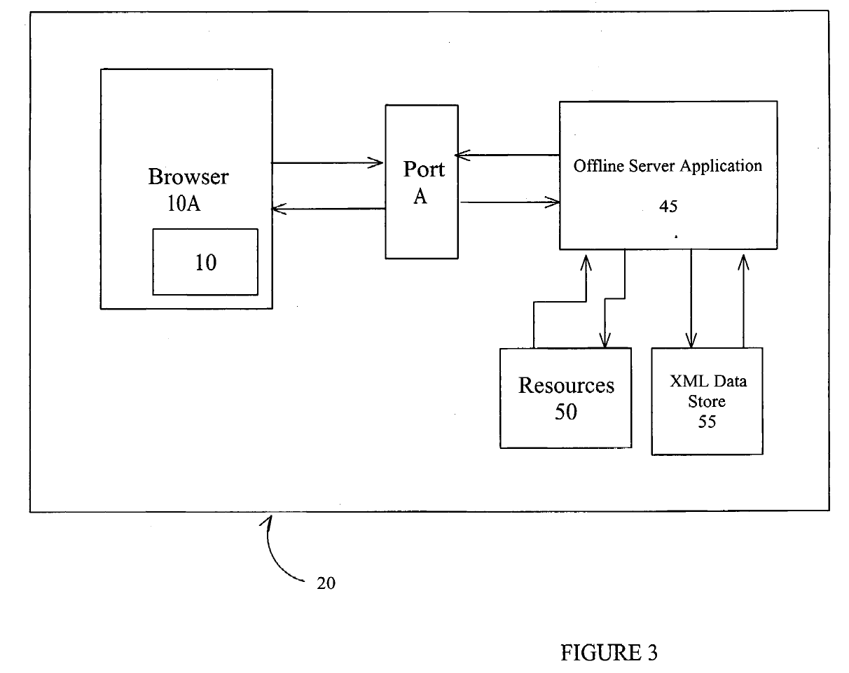

One approach to converting a normally online application into an offline application would be to replicate the server resources 35 required by the normally online application 10 on the client computer 20 including providing a server application on the client computer 20 so that requests normally handled by the online application on the server computer can be handled locally. This approach is illustrated in FIG. 3. In FIG. 3, the application 10 requests resources by making calls to an offline server application 45 (an offline HTTP server application, in one embodiment) stored and executing on the client computer 20. These resources are replicated on the client computer 20 as local resources 50. In many cases, these local resources are specific to the authenticated user. Requests for resources are made to the offline server application 45 and the offline server application 45 retrieves the requested resources from the local resources 50. For database queries or for requests for data to be written to a database, the offline server application 45 communicates with database resource 55 (referred to as an XML Data Store in the Figures) also stored on the client computer 20. Such database resources will be explained further below.

In the above approach, the subject application need not be rewritten as its functionality in the offline mode is identical to that in the online mode. Similarly, there is no change in the user interface between the online or the offline mode. Indeed, the application 10 is not even aware of its mode as its calls, requests, and accesses for resources are the same whether in the online mode or the offline mode. As long as the local resources 50 are a suitable copy of the resources which the application 10 may require or request from the server, then there should be no difference between the online and the offline functioning of the application. With respect to responses to the application's calls and requests, even though the responses to the requests made by the application to the offline server application may change as the data changes, the format is consistent between the online and offline modes.

It should be noted that the browser 10A points to a local port A on the client computer 20. Thus, all accesses to the offline server 45 are routed through port A. The offline server application 45 monitors this port for any incoming accesses from the application 10.

In one implementation of this approach, the offline server application 45 uses the HTTP (Hypertext Transfer Protocol) to communicate with the browser 10A and, by extension, the application 10 being executed by the browser 10A. The browser 10A also uses HTTP to communicate with the server. The offline server application 45, much like the online server application 25, (denoted as HTTP Server in the Figures) not only retrieves resources requested by the subject application 10 but also executes methods which implement business-logic type functionality when requested by the subject application 10. The server application 25 resident on the server computer 30 also retrieves and/or manipulates data in the database 47 (see FIGS. 1 and 2). For the offline server application 45 on the client computer 20, the data to be retrieved and/or manipulated (perhaps as part of a business-logic type functionality) is part of the database resource 55.

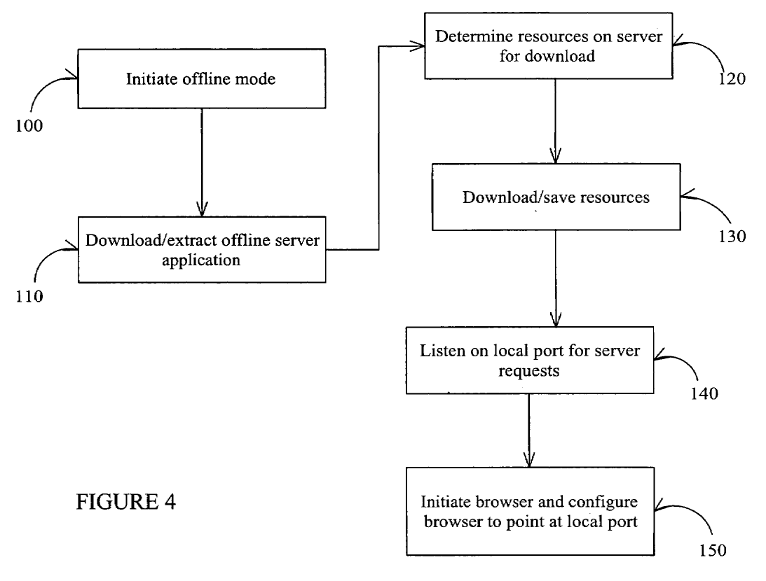

To implement the above noted approach, the steps shown in FIG. 4 are followed. The initial step (step 100) is that of initiating the offline mode. This may be done by the user explicitly activating an offline mode in the subject application. This starts a series of actions which will be explained below.

Step 110 is the downloading of an offline version of the server application, the offline server application. This offline server application is to be installed on the client computer and is to receive requests from the application. The offline server application is also configured to respond to these requests from the subject application using locally saved resources as will be explained below. The offline server application may be downloaded as part of a bootstrap module. The bootstrap module is, ideally, an executable module which, when executed, extracts a compressed version of the offline server application. The bootstrap module, once executed, also configures the client computer (if required) and any applications which may need to be configured. The offline server application may be downloaded as part of the bootstrap module or it may be downloaded separately. If the offline server application is downloaded as part of a bootstrap module, the bootstrap module extracts the offline server application from its compressed or uncompressed format for execution. As may be imagined, it is preferable that all the downloaded files are received by the client computer in compressed format for bandwidth management efficiency. It should be noted that, depending on the preconfiguration of the bootstrap module or the type of server application being saved on the client computer, there may be other different offline modules available for download by the bootstrap module as different types of normally online applications may have different requirements.

While different offline modules may have different contents and configurations for different types of online applications, one common task which the offline server application is designed to accomplish is that of determining which resources installed on the server computer are to be downloaded and saved on the client computer. This step of determining which resources resident on the server (step 120) are required may be accomplished by having the offline server application analyze the subject application. For the browser based subject application illustrated in FIG. 2, this is done by recursively reading (and thereby downloading) the HTM/XHTML files of the subject application. Initially, the root HTML/XHTML file is downloaded, saved, read, and then analyzed. All files referred to in the root HTM/XHTML file are downloaded and saved on the client computer. The other HTM/XHTML files downloaded and saved on the client computer are then similarly read and analyzed and the files that they refer to are also downloaded and saved on the client computer. By performing the analysis, downloading and saving of referenced files on each of the HTML/XHTML files of the subject application in a recursive manner, all the resources required by the subject application are saved on the client computer.

As an example of the above, if the root file refers to or accesses code files A, B, and C on the server, these files are retrieved and similarly analyzed recursively. If file A refers to image files A1, A2, A3 and text files A4, and A5, and A6, all of these files are identified/tagged as being required by the subject application. These are then downloaded and saved on the client computer. It should be noted that, when determining which files are required by the subject application, not only is an identification of the resource useful, but the identification of the location of that resource on the server would also be useful. It should further be noted that the resources on the server which may be required by the subject application may include database files and other data resources.

Once the resources on the server have been identified in step 120, the next step is that of downloading and installing these resources on the client computer (step 130). Since the resources had been identified and, preferably, their location on the server has been pinpointed, then downloading these resources can be accomplished. When installing these resources on the client computer, it is preferable if the directory structure of the server is, as much as possible, replicated on the client computer. This is preferable as it would simplify the task of locating the resources on the client computer when needed. Also, it is preferable if the resources were installed in a subdirectory on the client computer that will not encounter permission issues later on. A directory which is freely available to the user, such as the “My Documents” directory, may be used as the target installation directory for the resources to be downloaded from the server. This way, the offline server application, which will be performing the downloading and installation, will not normally encounter permission or access issues when doing so. It should be noted that this same directory may be used as the target directory for the downloaded offline server application. If a bootstrap module is used, the bootstrap module may be downloaded into and executed from a subdirectory of the directory freely available to the user. The offline server application may, as noted above, be saved and executed from such a subdirectory to avoid most permission issues.

To minimize the download times for the data resources, the required files may be data compressed to reduce bandwidth requirements. The use of commercially available compression software may be tied to the offline server application so that the compression software may be automatically executed on the server computer to compress the files to be downloaded to the client computer. Preferably, if such an approach is to be used, the paths and the directory structure of the resources would be preserved in the compressed files.

Other schemes by which the relevant files are transferred to the client computer may also be used. In one scheme, instead of downloading files after an analysis of each source HTML/XHTML file, the files to be downloaded may be placed on a list and the files listed may be compressed into a single compressed file for downloading to the client computer.

It should be noted that if at least one database is part of the resources to be downloaded, it may not be practical to download the whole database. As such, only a portion of the database may be downloaded and installed on the client computer. As an example, if the subject application was a timesheet application for a project, instead of downloading the complete database for the project, a subset of the database, such as perhaps covering a period of 16 weeks, is downloaded. As with the compression, such an approach lessens the amount of time required for the download as well as allowing the installed resources to be manageable.

Another possible approach regarding the database would be, instead of downloading a subset of the database, to download files (in XML format) that are a representative subset of the data from the database. These XML files, denoted above as database resources, are labeled as “XML Data Store” in FIG. 3. Relevant data from the database (such as data relating to a predetermined period for a timesheet application) is extracted from the database and formatted into a number of XML files. These XML files are then downloaded and stored in the client computer as the database resources. Methods invoked from the subject application to the offline server application may require reads and/or writes to this database resource. When this occurs, the appropriate XML is retrieved or updated. Afterwards, an appropriate response is sent to the subject application.

Once the relevant resources have been downloaded and saved on the client computer, the offline server application can then listen to a local port to which requests from the browser will be sent. (step 140). In one implementation, the browser is initiated on the client computer and is directed to point to a local port on the client computer (step 150). Thus, any requests from this browser (and hence from the subject application being executed through the browser) are directed to this local port.

In another implementation, a proxying application is used. The proxying application intercepts requests before or after they leave the browser and these requests are then relayed to the offline server application. This scheme may be used regardless of whether a browser is used or not. The separate application (the proxying application in this scheme) running in the background may be used to monitor accesses or requests from the subject application. Such a background application may then “trap” and direct the accesses or requests to the local port or to an offline server application.

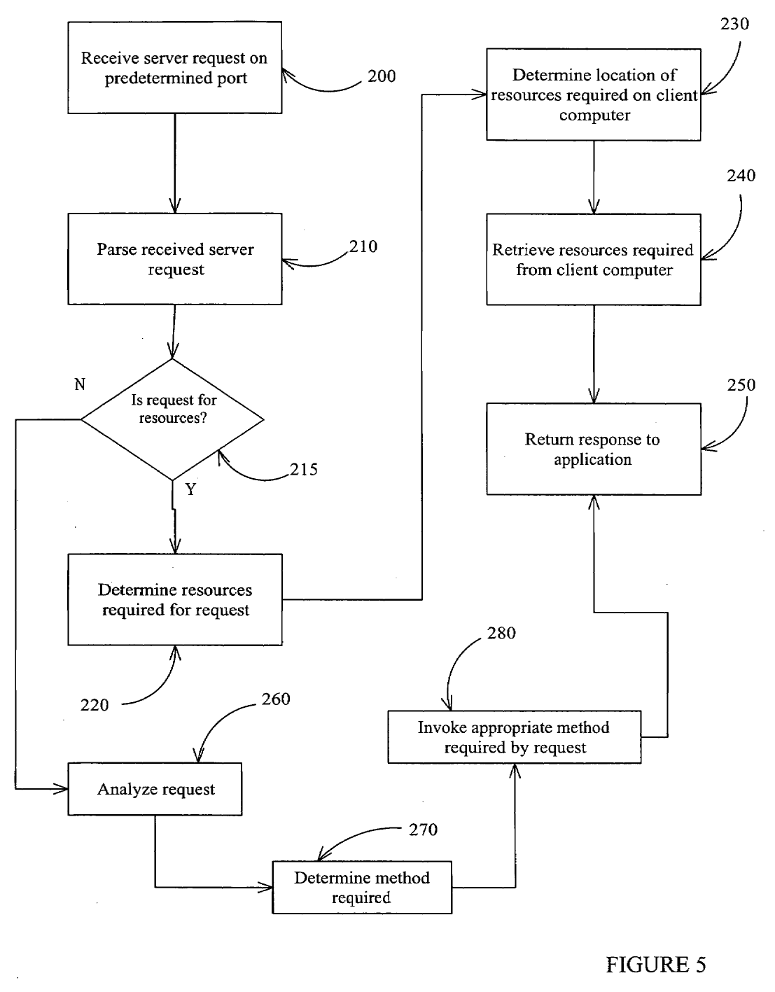

With the browser requests being directed to the local port on the client computer (step 150), and with the offline server application listening to the local port for such requests (step 140), the offline server application can process requests from the subject application. If such an access or request is received by the offline server application by way of the local port, the method illustrated in the flowchart of FIG. 5 is then executed.

Referring to FIG. 5, the first step after a request/access is made to a server application, once the subject application is in offline mode, is that of receiving the request/access on a local port (step 200). This request/access is, in one implementation, directed from the browser to the local offline server application and the request/access is handled by the offline server application. The next step (step 210) is that of parsing the received request. Parsing generally applies to the division of an array or a buffer of bytes into its specified parts. For this solution, parsing involves separating the different parts of the request so that the type of request can be determined as well as the resources required by the request/access. This specific type of parsing involves dividing a string of characters into different parts. As an example, the request string could be
GET www.server.com/images/header.jpg
Parsing this example of a request gives the following result:
Type of request: GET
Resource requested: header.jpg
Location of resource on server: www.server.com/images
Other types of requests, such as POST requests, are also possible.

The next step, decision 215 then determines the type of request being made by the browser. If the request is for resources (i.e. copies of image files, background files, data, etc.), then the offline server application is to locate these files from the downloaded resources saved on the client computer. GET requests usually involve the retrieval of files by the offline server application for the browser. On the other hand, other types of requests, such as POST requests, may require the execution of methods internal to the offline server application. Such methods may implement business-logic types of functionality and/or accesses to database resources. These requests may require the return of data and/or files to the requesting browser. If decision 215 determines that the browser request is a request for resources, then the next step is step 220.

Step 220, that of determining the resources required by the request, follows after the type of request has been determined. With the request now divided into different sections by the parsing, the resource(s) required by the request is easily determined. Similarly, step 230, that of determining the location of the required resource, is easily accomplished from the parsed request. From the parsed request, the location on the server of the required resources is known. If the directory structure of the resources on the server has been preserved on the client computer, then the location of the required resource can easily be found by translating the server location to a corresponding location on the client computer. As an example, if the relative path on the server for required files is
<somepath>/images
   the path for the required resource may be translated on the client computer to be
<relative path on client computer>/server/images
   with serverimages being subdirectories being created on the client computer when the resources were installed.

After the location of the required resources has been determined on the client computer, these resources are then retrieved in step 240.

The final step is that of returning the requested resource to the subject application (step 250).

If decision 215 determines that the request received in step 200 is not a request for a resource, then the logic flow of the flowchart in FIG. 5 moves from decision 215 to step 260. Step 260 analyzes the request to determine what is required by the request. This is done by, after parsing the server request, determining the various parts of the request. Step 270 determines which method internal to the offline server application is being called by the request. Parameters to be passed to the relevant method are also extracted from the request at this stage. Once the name of the method to be invoked by the offline server application is determined, the correct function point to call in the offline server application is found by cross-referencing the method name on a lookup table. It should be noted that in other implementations, these steps could differ.

With the parameters for the method already extracted, these parameters are passed to the method and the method is invoked (step 280). If the method requires a response to be sent back to the browser, a proper response is created by the offline server application and sent to the browser (Step 250). It should be clear that, regardless of the request type, a response is always returned to the browser. As an example, a request for a business logic action, after executing the business logic, may return an appropriate HTTP response but the response may not contain any XML data.

It should be noted that, in one implementation, the request sent from the browser is required to have a specific format which includes, for POST requests, not just the name of the required method but also any additional parameters required. The body of the request, XML data in this implementation, is extracted from the request and the relevant parameters (e.g. the parameters in XML format, a response XML object for creating a response to the request, and a cookie object) are packaged into an object. This object is then passed to the method which is to be invoked. This approach provides the method with what it may require by way of the object passed to it: parameters in the form of XML, a cookies object to which may be written any cookie information required, and a response XML buffer to which may be written any XML response.

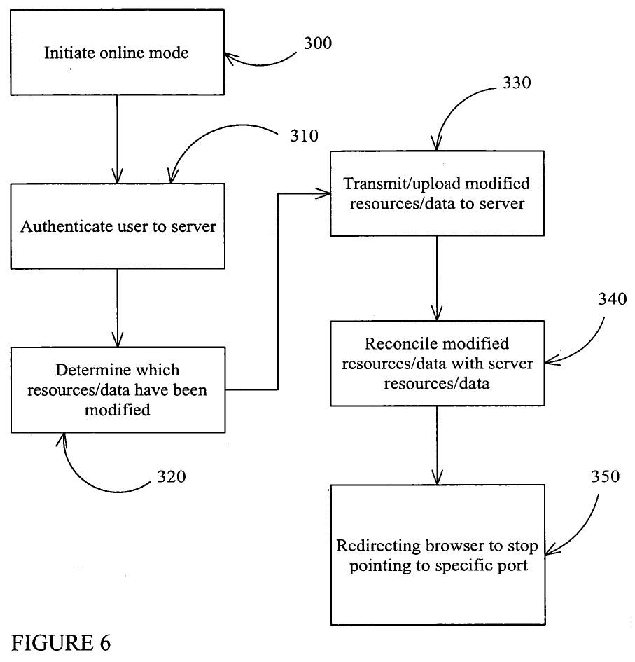

Referring to FIG. 6, a method for converting from offline mode to online mode is illustrated in the flowchart. The method begins with step 300, that of initiating the online mode. This is done by the user on the client computer after the client computer has reestablished a network connection that can connect it with the server computer.

The next step is that of authenticating the user to the server (step 310). This may be done by way of user IDs, passwords, digital certificates, or other methods well-known to the field of digital security and digital identity authentication.

Once the user has been authenticated, the offline server application determines which of the resources, usually data, installed on the client computer has been amended or modified (step 320). These resources would be the resources modified during the offline session and which must be reconciled with the resources on the server. This may be done by maintaining a list of resources modified during the offline session or by determining when the offline session began and, from that baseline, using the date/time stamp on the files on the client computer to find the modified files. Other methods, of course, may also be used.

Once the resources which have been modified have been determined, the next step (step 330) is that of transmitting or uploading the modified resources to the server. With a listing of the modified resources, transmitting the relevant data is easily accomplished.

With the modified resources now uploaded to the server, the modified resources are now reconciled with the data/resources on the server (step 340). Clearly, this is done on the server. The reconciliation may involve determining which portions of data have been edited and/or revised. These revised portions are then integrated into the data residing on the server. As may be imagined, this may involve inserting added data to a database on the server, revising database entries, updating database entries, and/or deleting relevant database entries.

In the implementation which uses XML files as the database resources, these XML files are reconstructed as XML payloads and, for each XML payload, the appropriate method on the server application resident on the server computer is called. The method then updates the database store within the server infrastructure based on the XML payload. Data such as time entries, cookies, and grid items may be updated for a timesheet application.

Finally, once the data/resources have been reconciled, the last step (step 350) is that of redirecting the offline application back to the original server and cleaning up any resources that were saved on the machine during offline use. This may involve reconfiguring the client computer, the subject application, the browser running the subject application (if applicable) or merely disabling (and possibly deleting) the offline server application. Also, this may involve removing the saved resources on the client computer.

Ajax calls (XmIHttpRequest) may be used to advantage to provide a responsive user interface for the application. In a timesheet application implementation, the timesheet application running on the browser has a user interface that is controlled almost entirely by HTML pages with Javascript code that dynamically manipulates the HTML page via the DOM (Document Object Model) based on responses received from the server application. What this means is that, instead of having to load a complete HTML page every time the user edits or changes an element on the timesheet, only portions of the HTML page are reloaded. The bulk of the code for the timesheet application running on the browser resides on the client computer and not on the server computer. This allows the same interface to be used for both the online and the offline modes of the timesheet application.

From the above, it should be clear that the offline server application to be executed on the client computer will have a different architecture from that of the online server application which executes on the server computer. The offline server application will have added functionality in terms of ensuring that resources are saved on the client computer. Furthermore, the manner in which the database queries and requests are handled may be different between the two server applications.

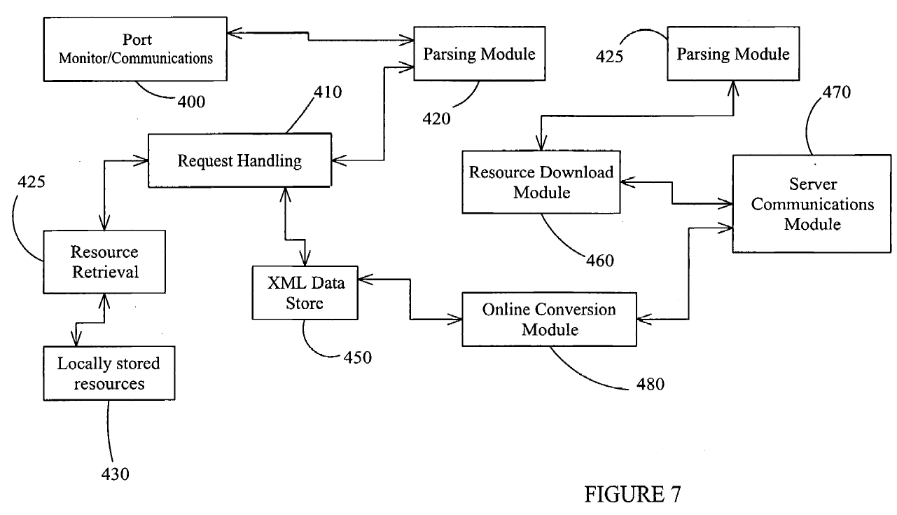

One possible architecture for the offline server application is that illustrated in FIG. 7. The various software modules schematically represented in FIG. 7 is not an exhaustive listing of the modules which may be present when the solution explained above is implemented.

A port monitor/communications module 400 is configured to monitor the local port for requests from the browser. This module 400 is also configured to receive these requests and to transmit responses to the browser. Once the request has been received, the request is passed to a parsing module 420 that is configured to parse the text/data of the request. The constituent parts of the request are then sent to a request handling module 410 to determine the type of request and how it should be dealt with. The request handling module 410 can, based on the data received from the parsing module 420, determine whatever methods may need to be invoked and/or what resources may need to be retrieved.

A resource retrieval module 425 may receive commands from the request handling module 410 based on the request received from the browser. The resource retrieval module 420 can then retrieve whatever resources have been requested from the locally stored resources 430 and these are passed back to the request handling module 410. The request handling module 410 is configured to create a suitable response to the requests and to transmit a response back to the browser by way of the port monitor/communications module 400.

Should the request require access to and/or manipulation of data from the database, then the request handling module 410 invokes the relevant functions to edit, change, retrieve, and/or save data to the database resources.

Also part of the offline server application is a resource download module 460. The resource download module 460 is configured to determine which resources have to be downloaded from the server computer, to download these resources, and to save these on the client computer. The resource download module 460 is designed to function with the parsing module 425 to determine, by the method noted above, which files are to be replicated on the client computer. The resource download module 460 transmits data to and receives data from the server computer by way of a server communications module 470. The server communications module 470 is configured to transmit and receive communications between the server computer and the offline server application. It should be clear from the figure that parsing module 420 is different from parsing module 425 as module 420 parses the text/data of requests from the browser while module 425 parses the source HTML/XHMTL to determine which files to download from the server computer.

An online conversion module 480 is designed to execute when a user wishes to convert the subject application to an online mode. The online conversion module 480 can thus communicate with the server computer by way of the server communications module 470. To synchronize data between the database resources on the client computer and then server computer, the online conversion module 480 communicates with the XML data store 450 to retrieve data items which have been changed. These can then be uploaded to the server computer.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for executing a normally online subject application in an offline mode on a client computer, the system comprising:
an offline server application executed on said client computer, said offline server application being for receiving and responding to requests from said subject application;
offline resources saved on said client computer, said offline resources being at least a subset of resources normally resident on a server remote from said client computer, said offline resources being for use by said subject application by way of said requests to said offline server application;
database resources stored on said client computer for use by said subject application by way of said requests to said offline server application, said database resources being representative of a subset of data stored on said server.

2. A system according to claim 1 wherein said subject application is executed through a web browser.

3. A system according to claim 2 wherein said web browser is directed to point to a local port on said client computer such that requests by said subject application are sent to said offline server application by way of said port.

4. A system according to claim 1 further including a bootstrap module for downloading and saving said offline server application on said client computer.

5. A system according to claim 1 wherein said subject application is a timesheet application.

6. A system according to claim 1 wherein said offline resources are downloaded from said server to said client computer by said offline server application prior to said subject application entering said offline mode.

7. A method for executing a normally online subject application in an offline mode on a client computer, the method comprising:
a) downloading resources from a server and installing said resources on said client computer, said resources being for use by said subject application and said resources normally being accessed by said subject application from said server when said subject application is in an online mode;
b) directing server accesses and requests by said subject application to an offline server application installed on said client computer, said offline server application being for receiving and responding to said requests from said subject application using said resources downloaded in step a).

8. A method according to claim 7 further including the step of, prior to step a), determining which resources on said server may be used by said subject application.

9. A method according to claim 7 wherein said application is executed through a web browser.

10. A method according to claim 9 wherein step-b) is accomplished by initiating said Internet web browser on said client computer and pointing said web browser to a local port on said client computer.

11. An offline server application for use with a normally online subject application when said subject application is in an offline mode, the offline server application being executed on a client computer and comprising:
a resource download module for downloading resources normally resident on a server remote from said client computer, said resources being for use by said subject application by way of requests to said offline server application, said resources being saved on said client computer by said offline server application;
a request handling module for receiving and handling requests from said subject application using resources downloaded from said server;
an online conversion module for synchronizing resources between said client computer and said server prior to said subject application operating in an online mode.

12. An offline server application according to claim 11 further including a port monitor module for monitoring a local port on said client computer, requests from said subject application being sent to said local port.

13. An offline server application according to claim 11 wherein said subject application is executed through a web browser.

14. An offline server application according to claim 13 wherein said resource download module determines which resources on said server are for downloading to said client computer by recursively retrieving and parsing code files for said subject application.
